(19) United States
(12) Patent Application Publication
(10) Pub. No.: US 2020/0220962 A1
(43) Pub. Date: Jul. 9, 2020

(54) SYSTEM AND METHOD TO TRANSMIT INFORMATION TO A USER BASED ON THEIR LOCATION IN RELATION TO A VEHICLE

(71) Applicant: GM GLOBAL TECHNOLOGY OPERATIONS LLC, DETROIT, MI (US)

(72) Inventors: Matthew C. Neely, Rochester, MI (US); Eric T. Hosey, Royal Oak, MI (US); Huong T. Chim, Madison Heights, MI (US); Russell A. Patenaude, Macomb Township, MI (US)

(21) Appl. No.: 16/243,413

(22) Filed: Jan. 9, 2019

(51) Int. Cl. H04M 1/725; H04W 4/02; H04W 4/40; H04W 4/80

(52) U.S. Cl. CPC H04M 1/7253; H04W 4/023; H04M 1/72525; H04W 4/80; H04W 4/40

(57) ABSTRACT

One general aspect includes a method to prompt a user for information upon being in proximity to a vehicle, the method including: realizing a user account requires vehicle information from the user; determining whether the user is within proximity of the vehicle; and prompting the user to provide the vehicle information based on the determination of whether the user is within proximity of the vehicle. Other embodiments of this aspect include corresponding computer systems, apparatus, and computer programs recorded on one or more computer storage devices, each configured to perform the actions of the methods.

### INTRODUCTION

Purchasing a vehicle can be an exciting event. This event can be even more exciting when the purchaser subscribes to vehicle services such as in-vehicle security, emergency services, hands-free calling, turn-by-turn navigation, remote diagnostics systems, or the like. In fact, buying a vehicle and subscribing to vehicle-related services can be so exciting that the purchaser completely forgets to add pertinent vehicle information to their subscription account, ensuring the subscription services can be carried out adequately. It is therefore desirable to provide a system and method that will remind the vehicle purchaser they have yet to provide this vehicle information as well as prompt them to provide the information at a time and place for which they will likely respond appropriately. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method to prompt a user for information upon being in proximity to a vehicle, the method including: realizing a user account requires vehicle information from the user; determining whether the user is within proximity of the vehicle; and prompting the user to provide the vehicle information based on the determination of whether the user is within proximity of the vehicle. Other embodiments of this aspect include corresponding computer systems, apparatus, and computer programs recorded on one or more computer storage devices, each configured to perform the actions of the methods.

Implementations may include one or more of the following features. The method further including: determining whether a current time falls within one or more time parameters; and where the user is prompted to provide vehicle information based on both the determination of whether the user is within proximity of the vehicle and the determination of whether the current time falls within the one or more time parameters. The method further including: determining whether inclement weather exists in an environment surrounding the vehicle; and where the user is prompted to provide vehicle information based on both the determination of whether the user is within proximity of the vehicle and the determination of whether the inclement weather exists in the environment surrounding the vehicle. The method further including: receiving vehicle location information from the vehicle; receiving user location information from a mobile computing device of the user; and where the determination of whether the user is within proximity of the vehicle is based on the user location in relation to the vehicle location. The method where the user is determined to be within proximity of the vehicle when a mobile computing device of the user can establish a short-range wireless connection (SRWC) with the vehicle. The method where the vehicle information is regarding a license plate being transferred to a new vehicle. The method where the user is prompted to provide, via a mobile computing device, a photo of a license plate of the vehicle. Implementations of the described techniques may include hardware, a method or process, or computer software on a computer-accessible medium.

One general aspect includes a system to prompt a user for information upon being in proximity to a vehicle, the system including: a memory configured to include one or more executable instructions and a processor configured to execute the executable instructions, where the executable instructions enable the processor to carry out the following steps: realizing a user account requires vehicle information from the user; determining whether the user is within proximity of the vehicle; and prompting the user to provide the vehicle information based on the determination of whether the user is within proximity of the vehicle. Other embodiments of this aspect include corresponding computer systems, apparatus, and computer programs recorded on one or more computer storage devices, each configured to perform the actions of the methods.

Implementations may include one or more of the following features. The system further including: the executable instructions enable the processor to carryout the step of determining whether a current time falls within one or more time parameters; and where the user is prompted to provide vehicle information based on both the determination of whether the user is within proximity of the vehicle and the determination of whether the current time falls within the one or more time parameters. The system further including: the executable instructions enable the processor to carryout the step of determining whether inclement weather exists in an environment surrounding the vehicle; and where the user is prompted to provide vehicle information based on both the determination of whether the user is within proximity of the vehicle and the determination of whether the inclement weather exists in the environment surrounding the vehicle. The system further including: the executable instructions enable the processor to carryout the following steps: receiving vehicle location information from the vehicle; receiving user location information from a mobile computing device of the user; and where the determination of whether the user is within proximity of the vehicle is based on the user location in relation to the vehicle location. The system where the user is determined to be within proximity of the vehicle when a mobile computing device of the user can establish a short-range wireless connection (SRWC) with the vehicle. The system where the vehicle information is regarding a license plate being transferred to a new vehicle. The system where the user is prompted to provide, via a mobile computing device, a photo of a license plate of the vehicle. Implementations of the described techniques may include hardware, a method or process, or computer software on a computer-accessible medium.

One general aspect includes a non-transitory and machine-readable medium having stored thereon executable instructions adapted to prompt a user for information upon being in proximity to a vehicle, which when provided to a processor and executed thereby, causes the processor to carry out the following steps: realizing a user account requires vehicle information from the user; determining whether the user is within proximity of the vehicle; and prompting the user to provide the vehicle information based on the determination of whether the user is within proximity of the vehicle. Other embodiments of this aspect include corresponding computer systems, apparatus, and computer programs recorded on one or more computer storage devices, each configured to perform the actions of the methods.

Implementations may include one or more of the following features. The non-transitory and machine-readable memory which further causes the processor to carryout the step of determining whether a current time falls within one or more time parameters; and where the user is prompted to provide vehicle information based on both the determination of whether the user is within proximity of the vehicle and the determination of whether the current time falls within the one or more time parameters. The non-transitory and machine-readable memory which further causes the processor to carryout the step of determining whether inclement weather exists in an environment surrounding the vehicle; and where the user is prompted to provide vehicle information based on both the determination of whether the user is within proximity of the vehicle and the determination of whether the inclement weather exists in the environment surrounding the vehicle. The non-transitory and machine-readable memory which further causes the processor to carryout the following steps: receiving vehicle location information from the vehicle; receiving user location information from a mobile computing device of the user; and where the determination of whether the user is within proximity of the vehicle is based on the user location in relation to the vehicle location. The non-transitory and machine-readable memory where the user is determined to be within proximity of the vehicle when a mobile computing device of the user can establish a short-range wireless connection (SRWC) with the vehicle. The non-transitory and machine-readable memory where the user is prompted to provide, via a mobile computing device, a photo of a license plate of the vehicle. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system that is capable of utilizing the system and method disclosed herein;

FIG. 2 is a flowchart of an exemplary process to prompt a user for information upon being in proximity to a vehicle;

FIG. 3 depicts an application of an exemplary aspect of the process of FIG. 2 in accordance with one or more exemplary embodiments; and

FIG. 4 depicts an application of an exemplary aspect of the process of FIG. 2 in accordance with one or more exemplary embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

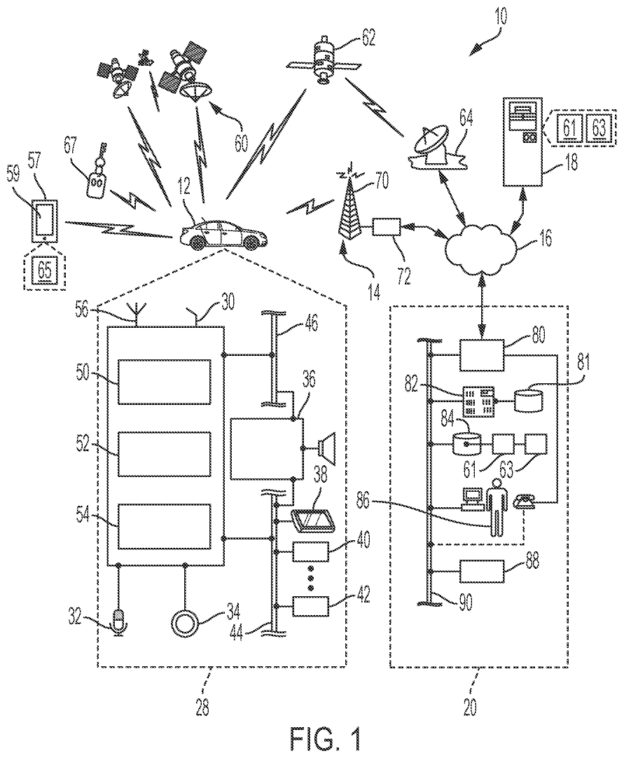

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including, but not limited to, motorcycles, trucks, busses, sports utility vehicles (SUVs), recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), WIFI, Bluetooth and Bluetooth Low Energy, a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket transceiver device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor 86 or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to standards such as LTE or 5G and thus includes a standard cellular chipset 50 for voice communications like hands-free calling, a wireless modem for data transmission (i.e., transceiver), an electronic processing device 52, at least one digital memory device 54, and an antenna system 56. It should be appreciated that the modem can either be implemented through software that is stored in the telematics unit and is executed by processor 52, or it can be a separate hardware component located internal or external to telematics unit 30. The modem can operate using any number of different standards or protocols such as, but not limited to, WCDMA, LTE, and 5G. Wireless networking between vehicle 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile computing device 57, such as a smart phone, personal laptop computer, smart wearable device, or tablet computer having two-way communication capabilities, a netbook computer, or any suitable combinations thereof. The mobile computing device 57 can include computer processing capability, a camera 55, a user interface 59, a transceiver capable of communicating with wireless carrier system 14, and/or a GPS module capable of receiving GPS satellite signals and generating GPS coordinates based on those signals. Examples of the mobile computing device 57 include the iPhone™ manufactured by Apple, Inc., and the Pixel™ manufactured by HTC, Inc. as well as others. While the mobile computing device 57 may include the ability to communicate via cellular communications using the wireless carrier system 14, this is not always the case. For instance, Apple manufactures devices such as the various models of the iPad™ and iPod Touch™ that include the processing capability, and the ability to communicate over a short-range wireless communication link such as, but not limited to, WIFI and Bluetooth. However, the iPod Touch™ and some iPads™ do not have cellular communication capabilities. Even so, these and other similar devices may be used or considered a type of wireless device, such as the mobile computing device 57, for the purposes of the method described herein.

Mobile device 57 may be used inside or outside of vehicle 12, and may be coupled to the vehicle by wire or wirelessly. The mobile device also may be configured to provide services according to a subscription agreement with a third-party facility or wireless/telephone service provider. It should be appreciated that various service providers may utilize the wireless carrier system 14 and that the service provider of the telematics unit 30 may not necessarily be the same as the service provider of the mobile devices 57.

When using a short-range wireless connection (SRWC) protocol (e.g., Bluetooth/Bluetooth Low Energy or WIFI), mobile computing device 57 and telematics unit 30 may pair/link one with another when within a wireless range (e.g., prior to experiencing a disconnection from the wireless network). In order to pair, mobile computing device 57 and telematics unit 30 may act in a BEACON or DISCOVERABLE MODE having a general identification (ID); SRWC pairing is known to skilled artisans. The general identifier (ID) may include, e.g., the device's name, unique identifier (e.g., serial number), class, available services, and other suitable technical information. Mobile computing device 57 and telematics unit 30 may also pair via a non-beacon mode. In these instances, the call center 20 may participate in pairing mobile computing device 57 and telematics unit 30. For example, the call center 20 may initiate the inquiry procedure between the telematics unit 30 and mobile computing device 57. And call center 20 may identify mobile computing device 57 as belonging to the user of vehicle 12 and then receive from the mobile computing device 57 it's unique mobile device identifier and authorize the telematics unit 30 via the wireless communication system 14 to pair with this particular ID.

The mobile computing device 57 additionally has a vehicle-related software application 65 (e.g., RemoteLink™ by OnStar, myChevrolet™ by General Motors, etc.) resident on its memory. This vehicle app 65 may be downloaded (e.g., from an online application store or marketplace) and stored on the device's electronic memory. When the vehicle app 65 is installed on the mobile computing device 57, in one or more embodiments, the user can be presented with an option to turn on a proprietary messaging service (e.g., Apple's Push Notification Services (APNS) service or Firebase Cloud Messaging (FCM) service). In one or more embodiments, the vehicle app 65 enables the mobile computing device user to manage remote start attempts from mobile computing device 57. In particular, the vehicle app 65 enables the user to sign up for a remote start service and to register one or more specific vehicles 12 with the remote start service. This information may be stored in the memory of mobile computing device 57 and accessible by vehicle app 65 which may be implementing one or more GUIs via user interface 59. This information may also be transmitted from the vehicle app 65 to data center 20, for storage in the user's account in the database 84. As is generally understood, telematics unit 30 will start the vehicle operations upon receiving one or more of these remote start attempts (which may be relayed through server 82).

Once SRWC is established, the devices may be considered bonded as will be appreciated by skilled artisans (i.e., they may recognize one another and/or connect automatically when they are in a predetermined proximity or range of one other. In other words—they may become, at least temporarily, network participants). Call center 20 may also authorize SRWC on an individual basis before completion.

A vehicle key fob 67 generally performs conventional remote keyless entry (RKE) functions (which can be via telematics unit 30 in conjunction with BCM 42). Moreover, the term “key fob,” as used herein, broadly includes not only separate transmitters attached to a key or set of keys by a loop or tether, but also portable remote transmitters regardless of whether they are attached to keys, as well as remote transmitters that are integrated together with a vehicle key as a single component. According to one embodiment, amongst other components, key fob 67 may include a protective housing, several user buttons, an RKE circuit, a power source, and an antenna. As is generally known of wireless key fobs 67, the user buttons enable a user to selectively activate different RKE functions at vehicle 12, including, but not limited to, locking and unlocking a door, arming and disarming a vehicle alarm system, activating a trunk release, panic signaling, remote ignition starting, and turning on interior and exterior lights. Of course, other buttons and RKE functions known in the art could also be used, including RKE functions that are performed automatically without the use of user buttons. Key fob 67 may automatically be paired/linked with telematics unit 30 via the SRWC protocol when within a wireless range. Call center 20 may also authorize SRWC pairing/linking on an individual basis before completion. Skilled artisans will understand key fob 67 may alternatively gain RKE functions via wireless communications with one or more other known electronics components in vehicle 12 (e.g., a Passive Entry/Passive Start (PEPS) module, Wireless Communications Module (WCM), etc.).

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services provided in connection with one or more vehicle system modules 42 (VSM); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other VSMs 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests.

As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art.

The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM, media streaming services (e.g., PANDORA RADIO™, SPOTIFY™, etc.), satellite radio, CD, DVD, and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions (i.e., capable of GUI implementation). Audio system 36 may also generate at least one audio notification to announce such third-party contact information is being exhibited on display 38 and/or may generate an audio notification which independently announces the third-party contact information. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more cellular network infrastructures (CNI) 72, as well as any other networking components required to connect wireless carrier system 14 with land network 16. Each cell tower 70 includes sending and receiving antennas and a base station, with the base stations from different cell towers being connected to the CNI 72 either directly or via intermediary equipment such as a base station controller. Cellular system 14 can implement any suitable communications technology, including for example, analog technologies such as AMPS, or the newer digital technologies such as, but not limited to, 4G LTE and 5G. As will be appreciated by skilled artisans, various cell tower/base station/CNI arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure (i.e., a network of interconnected computing device nodes). One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer (e.g., a SIP Presence server) where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other services information is provided, whether by communicating with the vehicle 12 or data center 20, a third-party services provider, or some combination thereof.

Computer 18 can, for example, store a web mapping service application 61 (e.g., GOOGLE MAPS™, APPLE MAPS™, etc.) which offers satellite imagery, street maps, 360° panoramic views of streets (Street View), real-time traffic conditions (e.g., GOOGLE TRAFFIC™), and route planning for traveling by foot, vehicle, bicycle, or public transportation. For example, mapping application 61 may provide interactive virtual map data to telematics unit 30 to be exhibited on display 38. The interactive map data may moreover provide support for proximity information and the establishing of a geofence for a given location (e.g., the user's residence). As skilled artists will understand, the geofence can use GPS or RFID technology to create a virtual geographic boundary (i.e., a virtual perimeter for a real-world geographic area, for example, a radius around a vehicle), which enables a response when a device or object (e.g., vehicle 12) is determined to be within that virtual geographic boundary.

Computer 18 can also, for example, store a weather prediction/forecasting application 63 (e.g., RADARSCOPE™, DARK SKIES WEATHER™, WEATHER BUG™, THE WEATHER COMPANY™, etc.) which provides location-based reporting live and forecast data on hyperlocal weather to system users. In particular, the weather app 63 can provide users with a wealth of meteorological data such as temperature, wind, and visibility on a minute-by-minute, hourly, or daily basis, as well as an extended 10-day forecast. For example, the weather app 63 can implement Doppler radar and satellite imaging to attain the current weather of a certain area (e.g., the vehicle location) and/or predict the weather of that area based on location information feedback from a system user or some other device (e.g., vehicle 12). A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system backend functions and, according to the exemplary embodiment shown here, generally includes one or more switches 80, servers 82, databases 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live advisor 86 by regular phone, backend computer, or to the automated voice response system 88 using VoIP. Server 82 can incorporate a data controller 81 which essentially controls the operations of server 82. Server 82 may control data information as well as act as a transceiver to send and/or receive the data information (i.e., data transmissions) from one or more of the data bases 84, telematics unit 30, and mobile computing device 57.

Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software, and firmware components. The live advisor phone can also use VoIP as indicated by the broken line in FIG. 1. VoIP and other data communication through the switch 80 is implemented via a modem (i.e., a transceiver), connected between the land communications network 16 and local area network 90.

Data transmissions are passed via the modem to server 82 and/or database 84. Database 84 can store user account information such as vehicle dynamics information and other pertinent subscriber information. For example, the user account provides subscription-based amenities such as: communications, in-vehicle security, emergency services, hands-free calling, turn-by-turn navigation, and remote diagnostics systems. In order to ensure that these services can be properly carried out, amongst other things, a user is required to provide pertinent subscriber information (e.g., certain vehicle information). For instance, the user may be required to provide the license plate number assigned to their vehicle because such information cannot be uploaded into the user account at the time of vehicle purchase (e.g., it has yet to be assigned to the vehicle at the time the information is being uploaded). In addition, database 84 can store mapping app 61 and weather app 63 (discussed above). Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

### Method

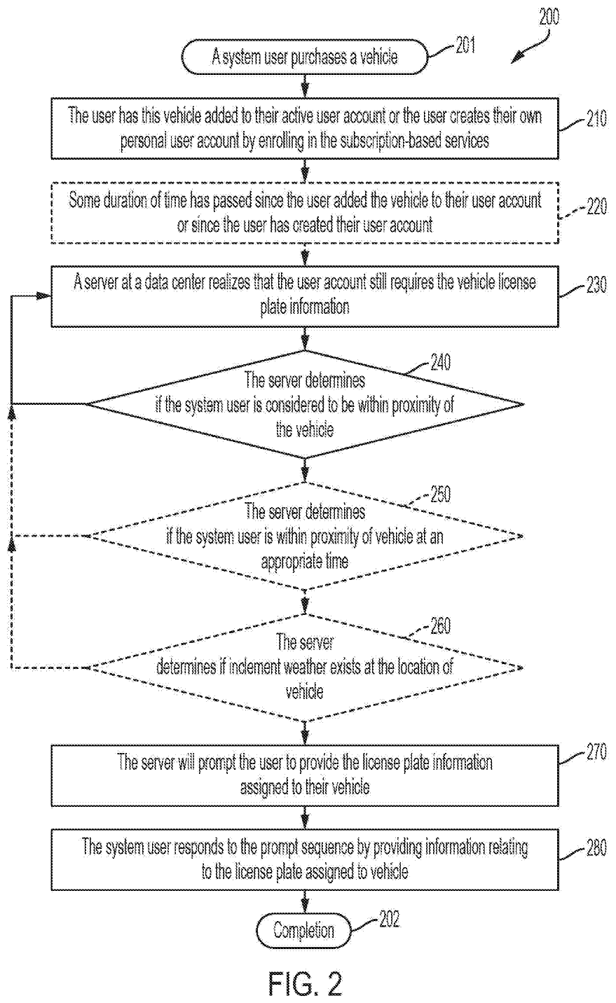

Turning now to FIG. 2, there is shown an embodiment of a method 200 to, upon approaching their vehicle 12, prompt a system user for their newly acquired license plate information as well as other pertinent vehicle services subscription information. One or more aspects of notification method 200 may be completed through data center 20 which may include one or more executable instructions incorporated into databases 84 (memory) and carried out by server 82 (processor). One or more ancillary aspects of method 200 may be completed by mobile computing device 57 and its GPS module, user interface 59, and camera 55. One or more ancillary aspects of method 200 may also be completed by one or more vehicle devices such as, for example, GPS chipset/component 40 and telematics unit 30 (e.g., to receive wireless signals from mobile computing device 57 in an effort to communicate via a SRWC protocol). One or more ancillary aspects of method 200 may further be completed by mapping app 61 and/or weather app 63. Skilled artisans will moreover see that telematics unit 30, data center 20, and mobile computing device 57 may be remotely located from each other.

Method 200 is supported by telematics unit 24 being configured to establish one or more communication protocols with data center 20. This configuration may be established by a vehicle manufacturer at or around the time of the telematics unit's assembly or after-market (e.g., via vehicle download using the afore-described communication system 10 or at a time of vehicle service, just to name a couple of examples). In at least one implementation, one or more instructions are provided to server 82 and stored on non-transitory computer-readable medium (e.g., database 84). In at least one implementation, one or more instructions are provided to the telematics unit 24 and stored on non-transitory computer-readable medium (e.g., digital memory device 54). Method 200 is supported by mobile computing device 57 being configured to establish one or more communication protocols with data center 20. This configuration may be established by a mobile computing device manufacturer at or around the time of the device's assembly. Method 200 is further yet supported by preconfiguring mobile computing device 57 to exhibit information on user interface 59 via one or more GUIs, store one or more corresponding software applications (e.g., vehicle app 65) in its electronic memory, and operate camera 55 to capture one or more images.

Method 200 begins at 201 in which a system user purchases vehicle 12. In step 210, the user has this vehicle added to their active user account in database 84 (e.g., the user has this vehicle 12 replace another vehicle in their active user account). Alternatively, the user creates their own personal user account by enrolling in the subscription-based services provided by data center 20. Moreover, in this step, the user account is updated to incorporate vehicle information for vehicle 12, which can be uploaded by the user or some other third party (e.g., a dealership representative). However, unfortunately, the government assigned license plate number for vehicle 12 is not uploaded to the active user account (e.g., since it is unknown to the user or some other third party at the time the user account is being updated).

In optional step 220, some duration of time has passed since the user adds vehicle 12 to their active user account or since the user has created the user account (i.e., time has passed since the end of step 210). For example, thirty (30) days has passed since this user account event. Skilled artists should see that this duration of time should be long enough to indicate that the user has had a license plate number assigned to their vehicle. Skilled artists will also see that this duration of time is long enough to indicate that the user has likely forgotten to upload their license plate to their user account (or at least they are putting off uploading this information for some reason).

In step 230, it is realized that the user account still requires the vehicle license plate information, for instance, to properly carry out one or more subscription services known to be provided by data center 20. For example, a timing mechanism may be associated with the user account (or the application program interface (API) incorporating the user account). This timing mechanism may moreover be designed to, after a certain duration of time (e.g., 30 days), notify server 82 that information is still needed from the user to finalize their user account. Moreover, in this step, server 82 will automatically monitor the user's mobile computing device 57 and vehicle 12, to see if the system user is in proximity to vehicle 12.

In step 240, server 82 determines if the system user is considered to be within proximity of vehicle 12 (i.e., at some location near vehicle 12 but not driving the vehicle 12). In one or more embodiments, this may occur after the telematics unit 30, which may be acting as a beacon, receives one or more SRWC signals from mobile computing device 57 and/or the key fob 67 (e.g., WIFI, BLE, etc.) and the unit recognizes mobile computing device 57 as being within SRWC range of vehicle 12. In other words, the user will be in proximity of vehicle 12 when their mobile computing device 57 (which should be being carried on the user's person) can establish a short-range wireless connection (SRWC) with telematics unit 30 via a SRWC protocol. In one or more alternative embodiments, the system user is considered to be within proximity of vehicle 12 when telematics unit 30 receives a remote start attempt from mobile computing device 57 or the key fob 67. In other words, the user will be in proximity of vehicle 12 when they are close enough to their vehicle 12 to start its operations or at least have the intent of being close to their vehicle 12 in the near future.

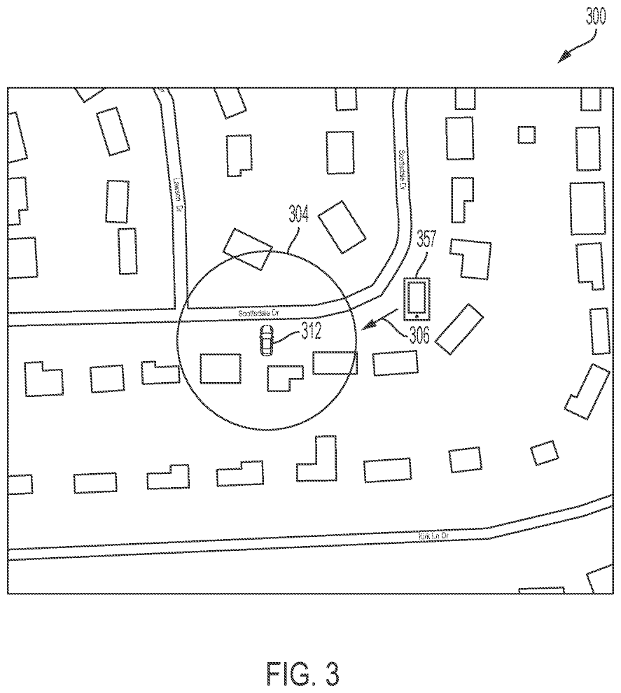

In one or more alternative embodiments, with reference to FIG. 3, server 82 may implement mapping app 61 to determine whether the system user is within proximity of vehicle 12. For example, server 82 will retrieve a virtual map 300 from mapping app 61 (e.g., resident on computer 18 or database 84). Server 82 will also attain the GPS coordinates of vehicle 12 (vehicle location data) by communicating with telematics unit 30 and GPS module 40. Server 82 will then establish a virtual vehicle location 312 on virtual map 300. In addition, server 82 will attain the GPS coordinates of the user by communicating the mobile computing device 57 and its internal GPS module (not shown). Server 82 will then establish a virtual user location 357 on virtual map 300.

Moreover, in this step, server 82 can establish a virtual geographic boundary 304 (e.g., geofence) around the virtual vehicle 312 established on the virtual map 300. The virtual geographic boundary 404 would represent, for example, a radius of 30 yards around the vehicle's location 312 (or some other distance in which the system user could see the license plate that has been affixed to their vehicle 12). As follows, when the virtual user location 357 is calculated to be within geographic boundary 304, server 82 would determine that the user is in proximity of vehicle 12. Otherwise, the server 82 would determine that the user is too far from the vehicle to be within its proximity. Server 82 could also calculate the direction and speed of the user's travel (i.e., the user's vector of travel 306) by receiving multiple GPS coordinates from mobile computing device 57. As follows, when the virtual user location 357 is calculated to be moving in the direction of virtual vehicle 312 and they are also calculated to be within geographic boundary 304, server 82 would determine that the user is in proximity of vehicle 12. Otherwise, the server 82 would determine that the user is either traveling away from vehicle 12 and thus not considered to be in proximity of vehicle 12 or the user is still at a location that is considered to be too far from the vehicle 12 to be considered within its proximity.

If server 84 determines that the system user is within proximity of vehicle 12, method 200 will move to step 250. Otherwise, method 200 will return to step 230 to go back to monitoring mobile computing device 57 and vehicle 12. Skilled artists will see that establishing locations on virtual maps 300 and virtual geographic boundaries have been well known in the art.

In optional step 250, server 82 determines if is the system user is within proximity of vehicle 12 at an appropriate time (e.g., during those hours typically associated with vehicle usage such as, for example, when the average person is known to commute to and from work). As follows, server 82 will review the current time via an internal clock program (i.e., the time at which server 82 has determined the user to be considered in proximity to vehicle 12). Server 82 will then determine if this current time falls within one or more time parameters (e.g., between 7:30AM and 10AM and between 3:30PM and 7:00PM). As can be understood, these time parameters can be associated with normal commute times because those are the times a system user would most likely be mentally and physically available to get information from their vehicle 12. However, it should also be understood that the time parameters can be associated with other events such as, for example, during day light hours or weekends. It has also been contemplated that one or more known machine learning techniques could be employed to determine when the user personally commutes to and from work. Furthermore, if server 82 determines the current time falls within one of the time parameters, method 200 will move to optional step 260; otherwise, method 200 to go back to monitoring mobile computing device 57 and vehicle 12.

In optional step 260, server 82 determines if inclement weather exists at the location of vehicle 12. For example, if it has not already been done, server 82 will attain the GPS coordinates of vehicle 12 by communicating with telematics unit 30 and GPS module 40. Server 82 will then implement weather app 63 to attain the current weather conditions for the area surrounding vehicle 12. Moreover, server 82 will determine whether these vehicle environment weather conditions are considered to be inclement weather conditions (e.g., thunder and lighting storms, 100% precipitation, etc.). This may be done upon a simple review and analysis of the weather status provided by weather app 63. If there is inclement weather in the area around vehicle 12, method will return to step 230. However, if the weather is non-inclement (i.e., the weather is suitable for a typical user to attain information from the exterior body of vehicle 12), method 200 will move to step 270.

In step 270, server 82 will prompt the user to provide the license plate information (or some other pertinent vehicle information) assigned to their vehicle 12. As such, server 82 will generate an information prompting program and transmit that program to the user's mobile computing device 57 or server 82 will cause vehicle app 65 to initiate the information prompting program stored on the mobile computing device 57. This virtual prompt program can, for example, be viewed as one or more GUIs presented on the user interface 59 via vehicle app 65. This prompt can also provide a statement to the effect of “OUR RECORDS INDICATE THAT YOUR ACCOUNT STILL REQUIRES YOUR VEHICLE′S LICENSE PLATE STATE AND NUMBER BE PROVIDED” or the like.

Along with this notification, in those instances the user has added vehicle 12 to their previously active user account (i.e., their user account has on file a license plate information associated with a previously owned vehicle), the prompt sequence can inquire whether the license plate information from their previous vehicle has simply been transferred to the newly owned vehicle 12. The prompt sequence can also provide one or more virtual buttons (via one or more GUIs) that allow the user to respond to this inquiry in the affirmative or the negative. Furthermore, in those instances when the user creates their user account for vehicle 12 (i.e., it is the first vehicle associated with the account) or when the user responds to the inquiry in the negative (i.e., there is a new license plate associated with vehicle 12), the prompt program can provide methods for the user to provide the new license plate information. For example, this prompt program can provide an input field that allows the user to type their new license plate number (and issuing State) into vehicle app 65 via user interface 59. Alternatively, the prompt can provide the user with the ability to capture and upload a photo of the license plate affixed to their vehicle (discussed below).

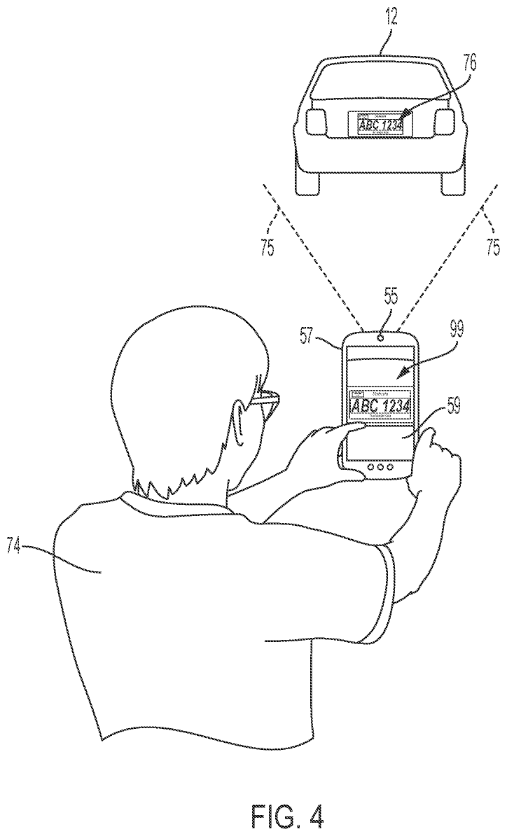

In step 280, the system user responds to the prompt sequence by providing information relating to the license plate assigned to vehicle 12. For example, when the license plate has simply been transferred from their old vehicle to their new vehicle 12, the user can simply respond to the inquiry in the affirmative (by pressing the corresponding virtual button)—as discussed above. In another example, the user types the license plate number (and State of issuance) into the input field provided by vehicle app 65—as discussed above. In another example, with reference to FIG. 4, the prompt sequence can enable the user to take and upload a picture of the license plate. As such, vehicle app 65 will instruct the user to activate camera 55 (which may be via vehicle app 65), point the field of vision 75 seen through camera lens at vehicle 12, adjust camera 55 to focus upon the targeted license plate 76 (in such a way to accurately capture the characters and symbols making up the registration number), and capture a photograph 99 of the license plate 76. Once the photo 99 has been taken, vehicle app 65 may transmit the photo 99 to server 82 to have the license plate information uploaded into the user account (which may be done manually—via live advisor—or automatically—via one or more software modules). Vehicle app 65 may also perform one or more object recognition techniques to parse and extract the license plate number (and State of issuance) from the photo and transmit this extracted information to the backend server 82, to have the information uploaded to the user account. After step 280, method 200 moves to completion 202.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

1. A method to prompt a user for information upon being in proximity to a vehicle, the method comprising:
generating, via a server at a remote entity, a user account associated with one or more subscription-based vehicle services;
after a duration of time from when the user account was generated, automatically realizing, via the server at the remote entity, the user account requires vehicle license plate information from the user so as to properly carry out one or more of the subscription-based vehicle services;
determining, via the server, whether the user is within proximity of the vehicle; and
prompting, via the server, the user to provide the vehicle license plate information based on the determination of whether the user is within proximity of the vehicle.

2. The method of claim 1, further comprising:
determining whether a current time falls within one or more time parameters; and
wherein the user is prompted to provide vehicle information based on both the determination of whether the user is within proximity of the vehicle and the determination of whether the current time falls within the one or more time parameters.

3. The method of claim 1, further comprising:
determining whether inclement weather exists in an environment surrounding the vehicle; and
wherein the user is prompted to provide vehicle information based on both the determination of whether the user is within proximity of the vehicle and the determination of whether the inclement weather exists in the environment surrounding the vehicle.

4. The method of claim 1, further comprising:
receiving vehicle location information from the vehicle;
receiving user location information from a mobile computing device of the user; and
wherein the determination of whether the user is within proximity of the vehicle is based on the user location in relation to the vehicle location.

5. The method of claim 1, wherein the user is determined to be within proximity of the vehicle when a mobile computing device and/or key fob of the user can establish a short-range wireless connection (SRWC) with the vehicle.

6. The method of claim 1, wherein the vehicle information is regarding a license plate being transferred to a new vehicle.

7. The method of claim 1, wherein the user is prompted to provide, via a mobile computing device, a photo of a license plate of the vehicle.

8. A system to prompt a user for information upon being in proximity to a vehicle, the system comprising:
a memory configured to comprise one or more executable instructions and a processor configured to execute the executable instructions, wherein the memory and processor are part of an entity remotely located from the user, wherein the executable instructions enable the processor to carry out the following steps:
generating a user account associated with one or more subscription-based vehicle services:
after a duration of time from when the user account was generated, automatically realizing the user account requires vehicle license plate information from the user so as to properly carry out one or more of the subscription-based vehicle services;
determining whether the user is within proximity of the vehicle; and
prompting the user to provide the vehicle license plate information based on the determination of whether the user is within proximity of the vehicle.

9. The system of claim 8, further comprising:
the executable instructions enable the processor to carryout the step of determining whether a current time falls within one or more time parameters; and
wherein the user is prompted to provide vehicle information based on both the determination of whether the user is within proximity of the vehicle and the determination of whether the current time falls within the one or more time parameters.

10. The system of claim 8, further comprising:
the executable instructions enable the processor to carryout the step of determining whether inclement weather exists in an environment surrounding the vehicle; and
wherein the user is prompted to provide vehicle information based on both the determination of whether the user is within proximity of the vehicle and the determination of whether the inclement weather exists in the environment surrounding the vehicle.

11. The system of claim 8, further comprising:
the executable instructions enable the processor to carryout the following steps:
receiving vehicle location information from the vehicle;
receiving user location information from a mobile computing device of the user; and
wherein the determination of whether the user is within proximity of the vehicle is based on the user location in relation to the vehicle location.

12. The system of claim 8, wherein the user is determined to be within proximity of the vehicle when a mobile computing device and/or key fob of the user can establish a short-range wireless connection (SRWC) with the vehicle.

13. The system of claim 8, wherein the vehicle information is regarding a license plate being transferred to a new vehicle.

14. The system of claim 8, wherein the user is prompted to provide, via a mobile computing device, a photo of a license plate of the vehicle.

15. A non-transitory and machine-readable medium being part of an entity remotely located from a user, the non-transitory and machine-readable medium having stored thereon executable instructions adapted to prompt the user for information upon being in proximity to a vehicle, which when provided to a processor and executed thereby, causes the processor to carry out the following steps:
generating a user account associated with one or more subscription-based vehicle services;
after a duration of time from when the user account was generated, automatically realizing the user account requires vehicle license plate information from the user so as to properly carry out one or more of the subscription-based vehicle services;
determining whether the user is within proximity of the vehicle; and
prompting the user to provide the vehicle license plate information based on the determination of whether the user is within proximity of the vehicle.

16. The non-transitory and machine-readable memory of claim 15, which further causes the processor to carryout the step of determining whether a current time falls within one or more time parameters; and
wherein the user is prompted to provide vehicle information based on both the determination of whether the user is within proximity of the vehicle and the determination of whether the current time falls within the one or more time parameters.

17. The non-transitory and machine-readable memory of claim 15, which further causes the processor to carryout the step of determining whether inclement weather exists in an environment surrounding the vehicle; and
wherein the user is prompted to provide vehicle information based on both the determination of whether the user is within proximity of the vehicle and the determination of whether the inclement weather exists in the environment surrounding the vehicle.

18. The non-transitory and machine-readable memory of claim 15, which further causes the processor to carryout the following steps:
receiving vehicle location information from the vehicle;
receiving user location information from a mobile computing device of the user; and
wherein the determination of whether the user is within proximity of the vehicle is based on the user location in relation to the vehicle location.

19. The non-transitory and machine-readable memory of claim 15, wherein the user is determined to be within proximity of the vehicle when a mobile computing device and/or key fob of the user can establish a short-range wireless connection (SRWC) with the vehicle.

20. The non-transitory and machine-readable memory of claim 15, wherein the user is prompted to provide, via a mobile computing device, a photo of a license plate of the vehicle.
